(19) United States
(12) Patent Application Publication
(10) Pub. No.: US 2019/0001165 A1
(43) Pub. Date: Jan. 3, 2019

(54) ATTACHMENT LOCK WITH SELF-RETRACTING DEVICE ADAPTER

(71) Applicant: Alexander Andrew, Inc. DBA Falltech, Compton, CA (US)

(72) Inventors: Cortland G. Schurian, Long Beach, CA (US); Michael Dancyger, Los Angeles, CA (US)

(21) Appl. No.: 15/635,331

(22) Filed: Jun. 28, 2017

(51) Int. Cl. A62B 35/00; A44B 11/04; A44B 13/00

(52) U.S. Cl. CPC A62B 35/0037; A62B 35/0075; A44B 13/0029; A44B 11/04

(57) ABSTRACT

A device includes a ring connection element having an opening configured to removably connect with a ring device, and a self-retracting device (SRD) attachment port integrated with the ring connection element.

### CROSS-REFERENCE TO RELATED APPLICATIONS

This application claims the priority benefit of U.S. Provisional Patent Application Ser. No. 62/409,779, filed Oct. 18, 2016, incorporated herein by reference in its entirety.

### BACKGROUND

The personal protective equipment (PPE) market has experienced a significant shift on the safety connection between the human body equipped with a safety harness and a secure anchor point. The traditional fixed length lanyards are being replaced by the use of self-retracting devices (SRDs). This market shift to SRDs has created several issues for the end users.

The relatively light weight fixed length lanyard is now being replaced by retractables, weighing significantly more, and is creating an industry wide safety issue for the end user in regards to the dorsal D-ring location. Due to the increased weight, the dorsal D-ring (the “D” shaped connector for SRDs) and any pad connected to it tends to slide down the user's back due to the weight of retractibles (often used in a set of two). This is creating a potentially catastrophic situation in both feet first and head first fall events due to movement of the SRD(s) connector point.

Typical installation of SRDs to the dorsal D-ring area is a time consuming process. Conventionally, the user needs to create a loop out of the torso webbing just below the dorsal D-ring then pass the SRD attachment point (often a safety rated carabiner) through this loop of webbing. This can be challenging for end users and can consume up to fifteen (15) minutes for installation and another fifteen (15) minutes for removal of the SRDs.

### SUMMARY

Embodiments relate to integration of a pre-established SRD connection point into a dorsal ring (e.g., D-ring, oval ring, etc.) “keeper.” One embodiment includes an apparatus that includes a ring connection element having an opening configured to removably connect with a ring device (e.g., a D-ring, oval ring, etc.) and an SRD attachment port integrated with the ring connection element. One embodiment connects to or is integrated with a base plate that includes one or more integrated tension clips to secure the SRD connection point and to prevent the entire assembly from re-positioning.

These and other features, aspects and advantages of the present invention will become understood with reference to the following description, appended claims and accompanying figures.

### BRIEF DESCRIPTION OF THE DRAWINGS

FIG. 1 shows a side view of an integrated SRD connection point and (dorsal) D-ring position keeper, according to an embodiment;

FIG. 2 shows a top view of the integrated SRD connection point and (dorsal) D-ring position keeper of FIG. 1, according to an embodiment;

FIG. 3 shows a side view of another integrated SRD connection point and (dorsal) D-ring position keeper, according to an embodiment;

FIG. 4 shows a top view of the integrated SRD connection point and (dorsal) D-ring position keeper of FIG. 3, according to an embodiment;

FIG. 5 shows a side view of yet another integrated SRD connection point and (dorsal) D-ring position keeper, according to an embodiment;

FIG. 6 shows a top view of the integrated SRD connection point and (dorsal) D-ring position keeper of FIG. 5, according to an embodiment;

FIG. 7 shows a perspective view of still another integrated SRD connection point and (dorsal) D-ring position keeper, according to an embodiment;

FIG. 8 shows a perspective view of an integrated SRD connection point and (dorsal) D-ring position keeper, according to an embodiment;

FIG. 9 shows a top view of the integrated SRD connection point and (dorsal) D-ring position keeper of FIG. 8 shown with an exemplary D-ring and harness, according to an embodiment;

FIG. 10 shows a perspective view of the integrated SRD connection point and (dorsal) D-ring position keeper of FIG. 9 shown with the exemplary D-ring and harness, according to an embodiment;

FIG. 11 shows an integrated webbing tension clip, according to an embodiment; and

FIG. 12 shows another integrated webbing tension clip, according to an embodiment.

### DETAILED DESCRIPTION

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Embodiments relate to integration of a pre-established SRD connection point into a dorsal ring (e.g., D-ring, oval ring, etc.) “keeper.” One embodiment includes an apparatus that includes a ring connection element having an opening configured to removably connect with a ring device (e.g., a D-ring, oval ring, etc.) and an SRD attachment port integrated with the ring connection element. One embodiment connects to or is integrated with a base plate that includes one or more integrated tension clips to secure the SRD connection point and to prevent the entire assembly from re-positioning.

Some conventional connection points are not fixed to a D-ring plate, which makes it hard for a user to attach this component and difficult for the component to remain in the correct location. Many conventional devices also fail to address the added weight of SRDs and the inherent slippage caused by this added weight. Other conventional SRD attachment points consist of a metal part built into or off of the dorsal D-ring. This is a heavy and costly alternative and does not address the slippage caused by the weight of SRDs added to a safety harness.

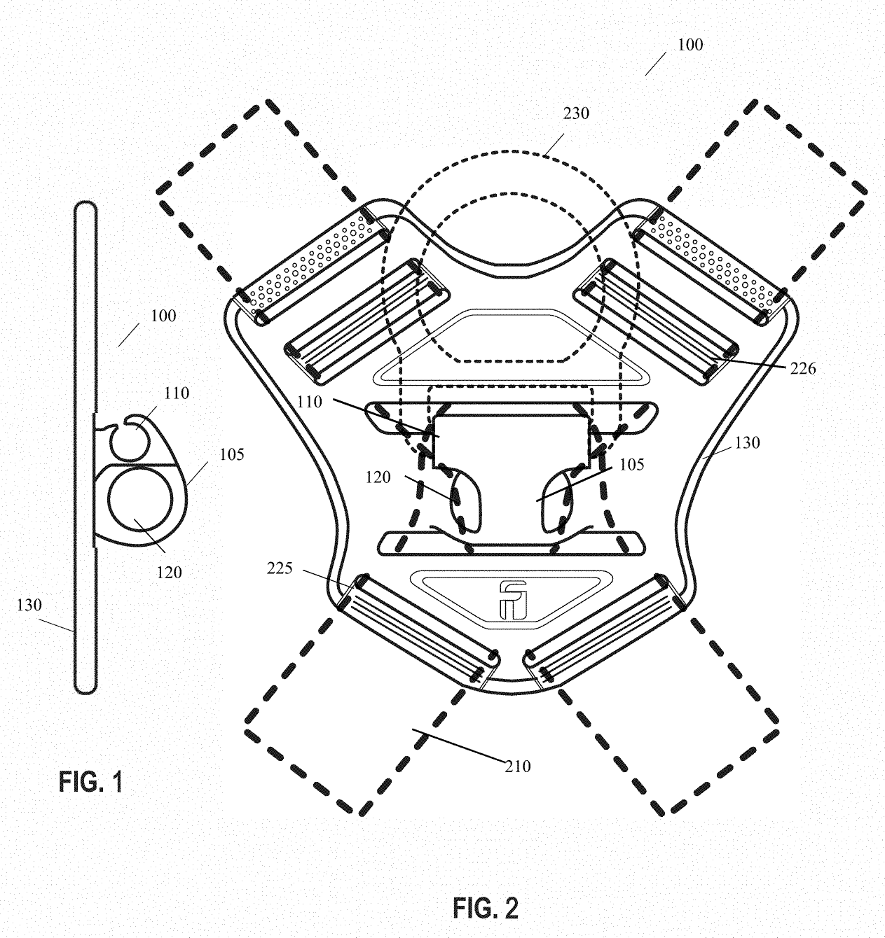

FIG. 1 shows a side view of a device 100 including an integrated SRD connection point 120 and (dorsal) D-ring position keeper (or connection point) 110, according to an embodiment. The device 100 includes a base plate 130, SRD connection point (or SRD quick attachment port) 120 with outer portion 105 and D-ring position keeper 110. In one embodiment, the D-ring position keeper 110 includes an opening for placement of a D-ring device (e.g., D-ring 230, FIG. 2), or other ring type devices (e.g., an oval ring, circular ring, etc.). The D-ring position keeper 110 provides stability of a D-ring that is placed in the D-ring position keeper 110 along with webbing (e.g., webbing 210, FIG. 2) that is placed over an opening portion of a D-ring (or other ring device). In one embodiment, the SRD connection point 120 includes a though-hole or slot for placement of an SRD connector (e.g., round carabiners, oval carabiners, etc. either made of aluminum, steel, etc.).

FIG. 2 shows a top view of the device 100 including the integrated SRD connection point 120 and (dorsal) D-ring position keeper 110 of FIG. 1, according to an embodiment. In one embodiment, the device 100 further includes webbing slots 225 and integrated tension clips 226 for webbing 210 (e.g., webbing from a safety harness). The webbing slots 225 provide a functional means to incorporate the torso webbing from a safety harness through the base plate 130 or the D-ring keeper 110 with an SRD adaptor assembly. Without this feature the critical dorsal D-ring placement would be lost and the safety of the user would be jeopardized.

In one embodiment, the base plate 130 is the foundation of the device 100 providing the surface in which to build all the other components on. The base plate 130 may be made in a variety of shapes and sizes, ranging from a simple flat shape to a complex multifaceted, multi-contoured shape. The base plate 130 may be sewn in place on padding, riveted, epoxy welded, etc. In one embodiment, the materials for the base plate 130 may range from steel, a steel alloy, an aluminum alloy, plastic resins, leather, fabric, etc.

In one embodiment, the D-ring keeper 110 is a feature that allows a (dorsal) D-ring 230 to maintain a safe and fixed distance from the SRD connection point 120. If the D-ring keeper 110 and the SRD connection point 120 are not within reasonable proximity of each other, the device 100 function can be jeopardized by becoming lost once the safety harness webbing 210 has been laced through the base plate 130 via the webbing slots 225 and integrated tension clips 226. The D-ring keeper 110 may also be strategically contoured or shaped to suit the intended D-ring 230 creating a stand-up or upright D-ring position, which makes it easier for the user to connect/disconnected lanyards and SRDs that are allowed to be connected directly to a dorsal D-ring. In one embodiment, the D-ring 230 is held in place by in a specific location. SRDs have a specific allowable usage marked on every unit. For example, the device can be used only for . . . overhead, 2′ below D-ring, 3′ below D-ring, 4′ below D-ring or foot level tie-off, etc. These are very specific instructions on personal SRDs. Therefore, if the SRD connection point 120 is too far away from the D-ring 230 one can end up with a miscalculation on the clear fall distance, which is the amount of distance one needs to calculate for a fall to prevent the user from hitting the lower level (or ground).

In one embodiment, the SRD connection point 120 creates a fixed loop on the base plate 130 allowing the torso webbing (e.g., webbing 210) from a safety harness to go over the top portion 105 and around the SRD connection point 120 to create a fast and safe connection for SRD attachment devices. The SRD connection point 120 may either be formed directly into the base plate 130 or permanently affixed to the base plate 130 through other means, such as riveting, cementing, a formed connection point method, etc. In one embodiment, materials used for the SRD connection point 120 may range from metal, metal alloy (e.g., steel alloy, aluminum alloy, etc.), plastic resins, leather, fabric, etc. The SRD connection point 120 may be made in the same material as the base plate 130, or alternative materials or an alternative material property (i.e., harder or softer).

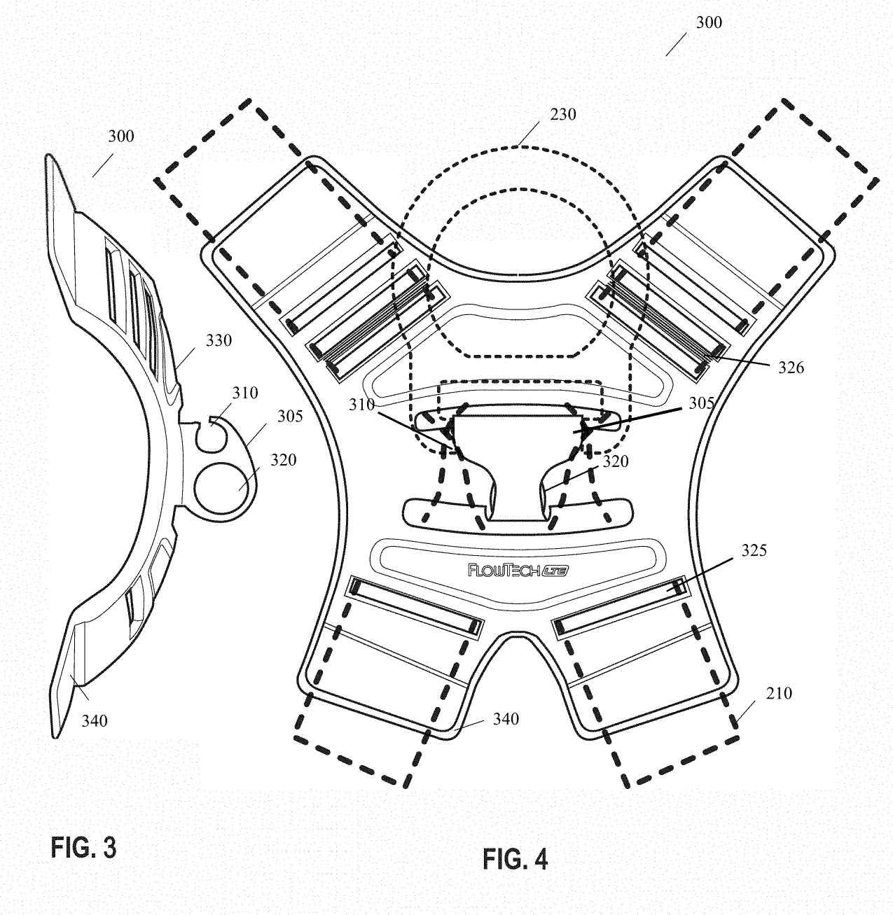

FIG. 3 shows a side view of a device 300 including another integrated SRD connection point 320 and (dorsal) D-ring position keeper 310, according to an embodiment. In one embodiment, the device 300 includes a curved or raised base plate 330, SRD connection point (or SRD quick attachment port) 320 with outer portion 305 and D-ring position keeper 310. Device 300 is similar to device 100 (FIGS. 1 and 2) albeit the shape, contour and position of components.

FIG. 4 shows a top view of the device 300 including integrated SRD connection point 320 and (dorsal) D-ring position keeper 310 of FIG. 3, according to an embodiment. In one embodiment, the device 300 includes four leg extensions 340 that may be placed in pockets of padding or a safety harness upper portion for stability of the base plate 330 and other components. The base plate 330 includes webbing slots 325 and integrated tension clips 326.

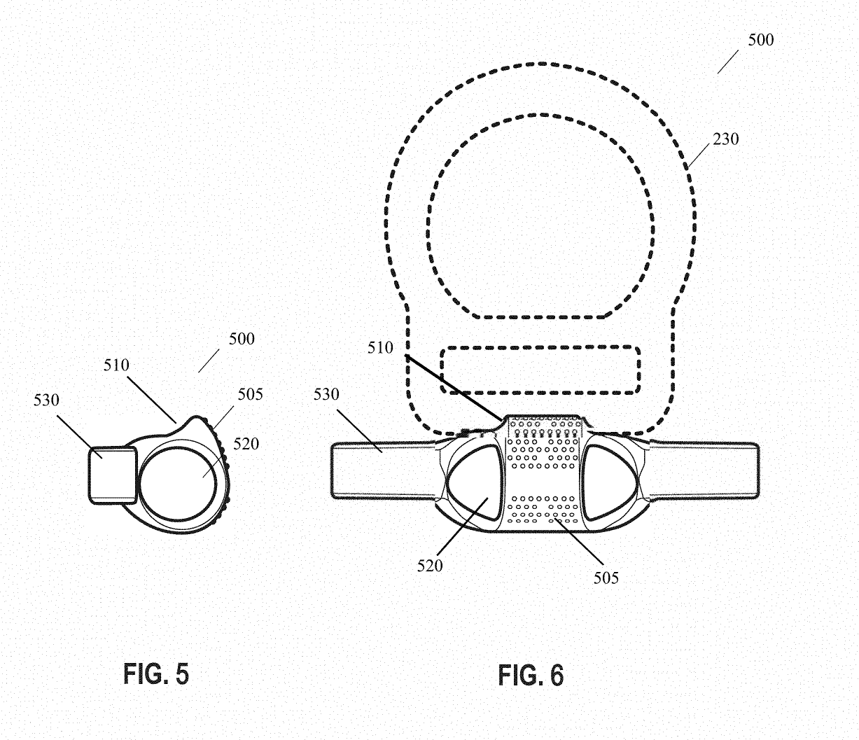

FIG. 5 shows a side view of a device 500 including yet another integrated SRD connection point 520 and (dorsal) D-ring position keeper 510, according to an embodiment. In one embodiment, the device 500 includes a curved or raised D-ring position keeper 510, SRD connection point (or SRD quick attachment port) 520 with outer portion 505 and attachment bar 530. The device 500 may be made of similar materials as the devices 100 and 300 discussed above.

FIG. 6 shows a top view of the device 500 including the integrated SRD connection point 520 and (dorsal) D-ring position keeper 510 of FIG. 5, according to an embodiment. In one embodiment, the device 500 is held in place by having the attachment bar 530 attached to padding or an upper portion of a webbing harness via sewing, welding, riveting, pockets formed around the attachment bar 530 ends, etc. In one embodiment, webbing is placed over the device 500 (e.g., over the outer portion 505, attachment bar 530) and through a lower opening of the D-ring 230. The curved portion of the D-ring keeper 510 maintains the D-ring 230 at a fixed distance from (positioned above) an SRD connector fastened through the SRD connection point 520.

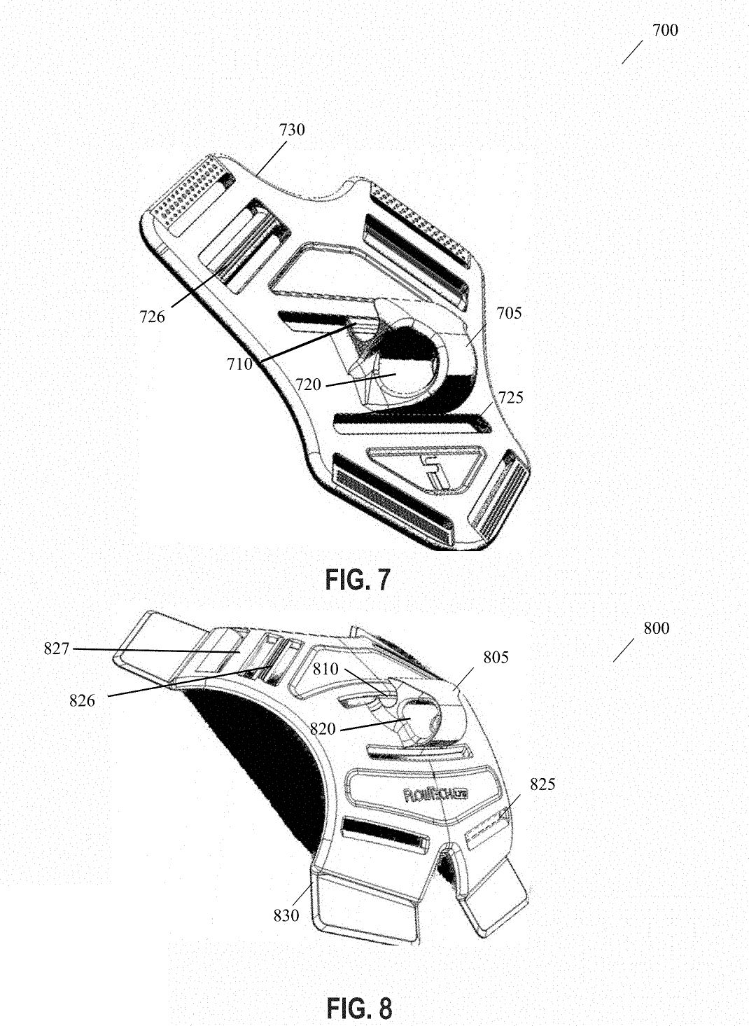

FIG. 7 shows a perspective view of a device 700 including still another integrated SRD connection point 720 and (dorsal) D-ring position keeper 710, according to an embodiment. In one embodiment, the device 700 includes a flat or almost flat base plate 730, outer portion 705 of the SRD connection point 720 and webbing slots 725 and integrated tension clips 726. The device 700 may be made of similar materials as device 100 and 300 as discussed above. In one embodiment, the integrated SRD connection point 720 and the D-ring position keeper 710 may be formed separately from the base plate 730 and attached to the base plate 730 via attachment means, such as welding, fasteners, etc. In another embodiment, the integrated SRD connection point 720 and the D-ring position keeper 710 may be formed together with the base plate 730 (e.g., molded together). The device 700 may be connected to the webbing (e.g., webbing 210, FIGS. 2 and 4) through the webbing slots 725.

FIG. 8 shows a perspective view of a device 800 including an integrated SRD connection point 820 and (dorsal) D-ring position keeper 810, according to an embodiment. In one embodiment, the device 800 includes a curved or raised base plate 830, outer portion 805 of the SRD connection point 820 and webbing slots 825 and integrated tension clips 826. The device 800 may be made of similar materials as device 100 and 300 as discussed above. In one embodiment, the integrated SRD connection point 820 and the D-ring position keeper 810 may be formed separately from the base plate 830 and attached to the base plate 830 via attachment means, such as welding, fasteners, etc. In another embodiment, the integrated SRD connection point 820 and the D-ring position keeper 810 may be formed together with the base plate 830 (e.g., molded together). The device 800 may be connected to the webbing (e.g., webbing 210, FIGS. 2 and 4) through the webbing slots 825.

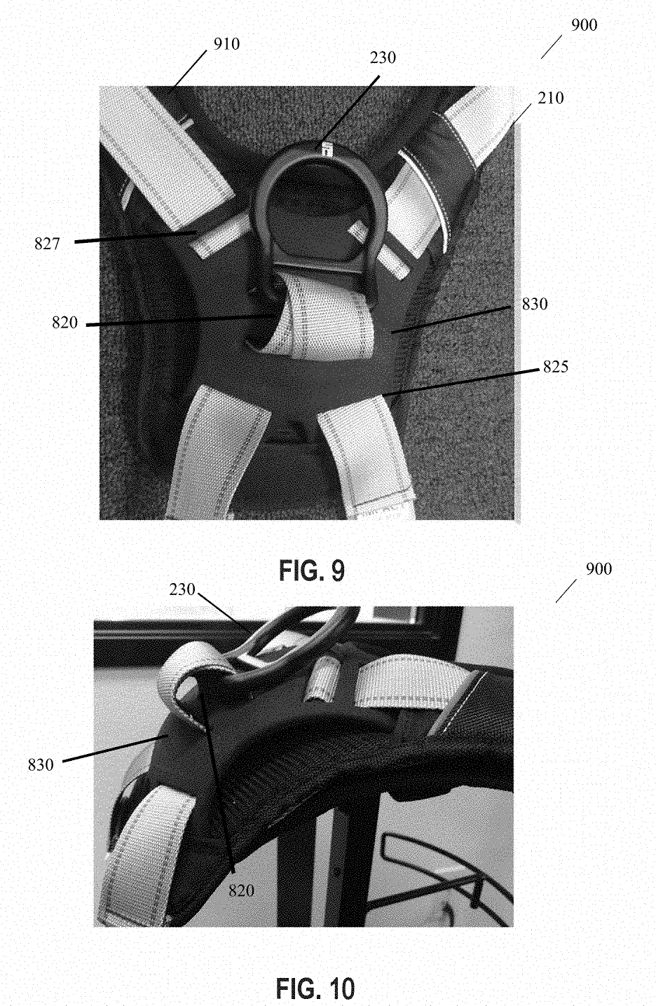

FIG. 9 shows a top view of an example 900 including the integrated SRD connection point 820 and dorsal D-ring position keeper 810 (not shown in FIG. 9 due to webbing 210) of FIG. 8 shown with an exemplary D-ring 230 and harness 910, according to an embodiment. As shown, the webbing 210 is placed through the webbing slots 825 of the base plate 830 and over the outer portion 805 (not shown as the webbing 210 covers the outer portion 805), through the opening in the lower portion of the D-ring 230 and back through further webbing slots 825.

FIG. 10 shows a perspective view of the device 900 of the integrated SRD connection point 820 and dorsal D-ring position keeper 810 of FIG. 9 shown with the exemplary D-ring 230 and harness 910, according to an embodiment.

In one or more embodiments, the outer shape of the devices incorporating a D-ring keeper and SRD connection point (e.g., device 100, FIGS. 1-2, 300, FIGS. 3-4, 500, FIGS. 5-6, 700, FIGS. 7, and 800, FIG. 8) along with the inner shape are strategically designed to serve specific purposes. In one example embodiment, the outer shape particularly the narrow top surface and sculpted curved sides along with the inner shape (e.g., oval in a vertical direction being taller than the horizontal direction) are all designed to accommodate common SRD connection options, such as oval carabiners, conventional shaped aluminum carabiners, steel carabiners, etc. that are common to the fall protection market. Without the shape designed in the above-discussed embodiments, the devices would be limited regarding the SRD connection options. In some embodiments, the top outer surface of the device is narrow and the device has sculpted curved sides along with an oval shape in a vertical direction being taller than the horizontal direction. This shape could also be made in the opposite direction with the sides narrow and the oval in a horizontal direction. In some embodiments, whatever direction the oval is taller or longer in, the outer shape has to be narrower in that same direction. In other embodiments, the shape of the through-hole or opening in the SRD connection point may be circular, oval, multi-faceted (e.g., pentagonal, octagonal, etc.), etc.

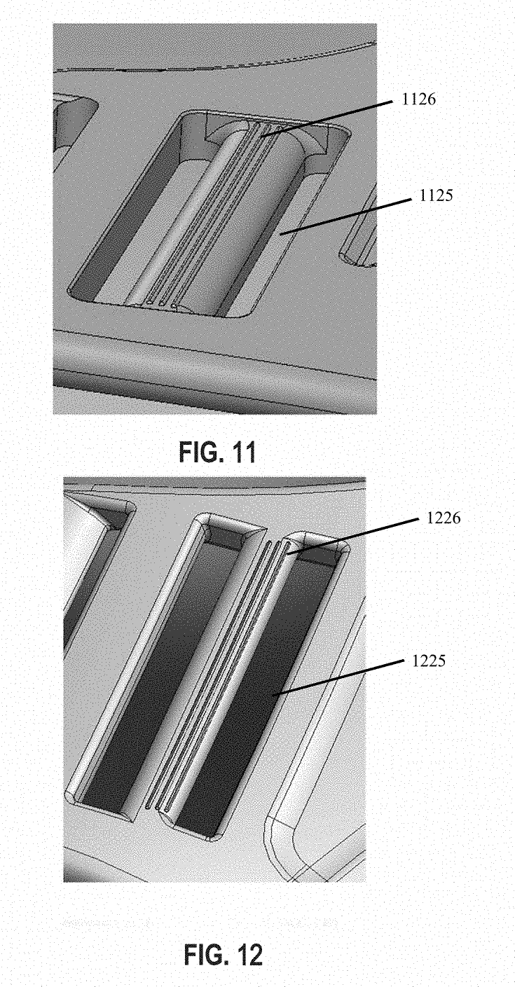

FIG. 11 shows an integrated webbing tension clip 1126 for webbing slots 1125, according to an embodiment. In one embodiment, the function of the integrated tension clip 1126 is to secure the (dorsal) D-ring keeper (e.g., D-ring keeper 110, FIGS. 1-2, 310, FIGS. 3-4, 510, FIGS. 5-6, 710, FIGS. 7, and 810, FIG. 8) in the properly specified location. While webbing slots (e.g., webbing slot 1125) help to hold the (dorsal) D-ring keeper to a safety harness by lacing the webbing through them, these fail to adequately secure the location of the (dorsal) D-ring keeper. In one embodiment, the integrated tension clip 1126 includes multiple raised gripping elements (e.g., 2 or more) on the top portion of the integrated tension clip 1126, which are designed to cause additional friction with webbing and prevent slipping of the webbing when inserted into the webbing slots 1125.

FIG. 12 shows another integrated webbing tension clip 1226 for webbing slots 1225, according to an embodiment. In one embodiment, the function of the integrated tension clip 1126 is to secure the (dorsal) D-ring keeper (e.g., D-ring keeper 110, FIGS. 1-2, 310, FIGS. 3-4, 510, FIGS. 5-6, 710, FIGS. 7, and 810, FIG. 8) in the properly specified location. In one embodiment, the integrated tension clip 1226 includes multiple raised gripping elements (e.g., 2 or more) that disposed on an angled portion of the integrated tension clip 1226, which are designed to cause additional friction with webbing and prevent slipping of the webbing when inserted into the webbing slots 1225.

References in the claims to an element in the singular is not intended to mean “one and only” unless explicitly so stated, but rather “one or more.” All structural and functional equivalents to the elements of the above-described exemplary embodiment that are currently known or later come to be known to those of ordinary skill in the art are intended to be encompassed by the present claims. No claim element herein is to be construed under the provisions of 35 U.S.C. section 112, sixth paragraph, unless the element is expressly recited using the phrase “means for” or “step for.”

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

1. An apparatus comprising:
a ring connection element comprising an opening configured for removably coupling with a ring device; and
a self-retracting device (SRD) attachment port integrated with the ring connection element.

2. The apparatus of claim 1, further comprising:
a base plate comprising a plurality of webbing slots, the base plate being coupled with the ring connection element and the SRD attachment port.

3. The apparatus of claim 2, wherein the base plate is one of integrated with the ring connection element and the SRD attachment port, or fixedly attached to the ring connection element and the SRD attachment port.

4. The apparatus of claim 3, wherein the ring connection element is positioned at a fixed distance from the SRD attachment port.

5. The apparatus of claim 2, wherein the ring connection element is configured to maintain position of a ring device in an upright position state.

6. The apparatus of claim 2, wherein the SRD attachment port is configured to couple with webbing over a top portion of the SRD attachment port.

7. The apparatus of claim 2, further comprising a base plate connection element, wherein the ring connection element comprises a curved portion configured to support a ring device.

8. The apparatus of claim 2, wherein the at least one webbing slot of the plurality of webbing slots comprises an integrated tension clip configured to couple with webbing to secure a position of a ring device coupled with the ring connection element.

9. The apparatus of claim 2, wherein the SRD attachment port comprises a through-hole configured for connecting to an attachment element connected to one or more SRDs.

10. The apparatus of claim 2, wherein the ring connection element comprises an open slot.

11. An apparatus comprising:
a ring connection element comprising an opening configured for removably coupling with a ring device; and
a self-retracting device (SRD) attachment port coupled to the ring connection element.

12. The apparatus of claim 11, further comprising:
a base plate comprising a plurality of webbing slots, the base plate being coupled with the ring connection element and the SRD attachment port, wherein the base plate is one of integrated with the ring connection element and the SRD attachment port, or fixedly attached to the ring connection element and the SRD attachment port.

13. The apparatus of claim 12, wherein the ring connection element is positioned at a fixed distance from the SRD attachment port, and the ring connection element is configured to maintain position of a ring device in an upright position state.

14. The apparatus of claim 12, wherein the SRD attachment port is configured to couple with webbing over a top portion of the SRD attachment port.

15. The apparatus of claim 12, further comprising a base plate connection element, wherein the ring connection element comprises a curved portion configured to support a ring device.

16. The apparatus of claim 12, wherein the at least one webbing slot of the plurality of webbing slots comprises an integrated tension clip configured to couple with webbing to secure a position of a ring device coupled with the ring connection element.

17. The apparatus of claim 2, wherein the SRD attachment port comprises a through-hole configured for connecting to an attachment element connected to one or more SRDs, and the ring connection element comprises an open slot.

18. An apparatus comprising:
a ring connection element comprising an opening configured to couple with a D-ring device; and
a self-retracting device (SRD) attachment port coupled to the ring connection element.

19. The apparatus of claim 18, further comprising:
a base plate comprising a plurality of webbing slots, the base plate being coupled with the ring connection element and the SRD attachment port, wherein:
the base plate is one of integrated with the ring connection element and the SRD attachment port, or fixedly attached to the ring connection element and the SRD attachment port;
the ring connection element is positioned at a fixed distance from the SRD attachment port;
the ring connection element is configured to maintain position of a ring device in an upright position state; and
the SRD attachment port is configured to couple with webbing over a top portion of the SRD attachment port.

20. The apparatus of claim 19, further comprising a base plate connection element, wherein:
the ring connection element comprises a curved portion configured to support a ring device;
the at least one webbing slot of the plurality of webbing slots comprises an integrated tension clip configured to couple with webbing to secure a position of a ring device coupled with the ring connection element;
the SRD attachment port comprises a through-hole configured for connecting to an attachment element connected to one or more SRDs; and
the ring connection element comprises an open slot.
